(19) United States
(12) Patent Application Publication
(10) Pub. No.: US 2025/0301408 A1
(43) Pub. Date: Sep. 25, 2025

(54) METHOD AND APPARATUS FOR COMMUNICATING USING LOW-POWER RECEIVER

(71) Applicant: KT CORPORATION, Gyeonggi-do (KR)

(72) Inventors: Eun Jong LEE, Gyeonggi-do (KR); Kyujin PARK, Gyeonggi-do (KR)

(73) Assignee: KT CORPORATION, Gyeonggi-do (KR)

(21) Appl. No.: 19/083,364

(22) Filed: Mar. 18, 2025

(30) Foreign Application Priority Data
Mar. 19, 2024 (KR) 10-2024-0038104
Mar. 10, 2025 (KR) 10-2025-0030531

(51) Int. Cl. H04W 52/02; H04B 17/318; H04W 24/08

(52) U.S. Cl. CPC H04W 52/0235; H04B 17/328; H04W 24/08

(57) ABSTRACT

Provided are a method and apparatus for communication using a low power wake up receiver (LR). A user equipment (UE) receives event information related to the LR, evaluates whether at least one event included in the event information is satisfied based on measurement using the LR, and performs a physical downlink control channel (PDCCH) monitoring operation if the at least one event is satisfied based on the evaluation.

### CROSS-REFERENCE TO RELATED THE APPLICATION

This application is based on and claims priority under 35 U.S.C. § 119 to Patent Application No. 10-2024-0038104 filed on Mar. 19, 2024 and No. 10-2025-0030531 filed on Mar. 10, 2025 in the Korean Intellectual Property Office, the disclosures of which are incorporated by reference herein in their entirety.

### BACKGROUND

### Technical Field

The present disclosure relates to wireless communication applicable to 5G NR, 5G-Advanced and 6G.

### Description of the Related Art

With the increase in the number of communication devices, there is a corresponding rise in communication traffic that must be managed. To address this increased communication traffic, a next generation 5G system, which is an enhanced mobile broadband communication system compared to the exiting LTE system, has become essential. Such a next generation 5G system has been designed based on scenarios which are classified into Enhanced Mobile BroadBand (eMBB), Ultra-reliability and low-latency communication (URLLC), Massive Machine-Type Communications (mMTC), and others.

eMBB, URLLC, and mMTC represent next generation mobile communication scenarios. eMBB is characterized by high spectrum efficiency, high user experience data rate, and high peak data rate. URLLC is characterized by ultra-reliable, ultra-low latency, and ultra-high availability (e.g., vehicle-to-everything (V2X), Emergency Service, and Remote Control). mMTC is characterized by low cost, low energy consumption, short packets, and massive connectivity (e.g., Internet of Things (IoT)).

### SUMMARY

The disclosure provides a method and apparatus for communication using a low power wake up receiver (LR) of a UE in a wireless communication system.

According to an embodiment, there is provided a method of operating a user equipment (UE) in a wireless communication system. The method may include receiving event information related to a low power wake up receiver (LR), evaluating whether at least one event according to the event information is satisfied based on measurement using the LR, and performing a physical downlink control channel (PDCCH) monitoring operation according to the satisfaction of the at least one event based on the evaluation.

According to another embodiment, there is provided a user equipment (UE) in a wireless communication system. The UE may include at least one processor; and at least one memory configured to store instructions and operably electrically connectable to the at least one processor, wherein operations performed based on the instructions executed by the at least one processor include: receiving event information related to a low power wake up receiver (LR), evaluating whether at least one event according to the event information is satisfied based on measurement using the LR, and performing a physical downlink control channel (PDCCH) monitoring operation according to the satisfaction of the at least one event based on the evaluation.

The measurement using the LR may include at least one of reference signal received power (RSRP) measurement and reference signal received quality (RSRQ) measurement.

Low power-wake up signal (LP-WUS) monitoring may be performing through the LR when at least one of the RSRP measurement and the RSRQ measurement is greater than or equal to a threshold, and the low power-wake up signal (LP-WUS) monitoring is stopped through the LR when at least one of the RSRP measurement and the RSRQ measurement is less than or equal to a threshold.

Meanwhile, the UE may evaluate whether at least one event, as defined by the event information, is satisfied based on measurement using the LR, and transmit report information to the base station accordingly. Here, the report information transmitted from the UE to the base station may include at least one of the following: i) information indicating coverage-in or -out of the LR; ii) information about results of measurement using the LR; and iii) indication information indicating a report on the results of the measurement using the LR. In addition, the report information transmitted from the UE to the base station may be sent through a main radio transceiver (MR).

### BRIEF DESCRIPTION OF THE DRAWINGS

FIG. 1 is a diagram illustrating a wireless communication system.

FIG. 2 is a diagram illustrating a structure of a radio frame used in new radio (NR).

FIGS. 3A to 3C illustrate exemplary architectures for a wireless communication service.

FIG. 4 illustrates a slot structure of an NR frame.

FIG. 5 shows an example of a subframe type in NR.

FIG. 6 illustrates a structure of a self-contained slot.

FIG. 7 is a diagram illustrating an exemplary operation of a UE with a low power-wake up receiver (LR).

FIG. 8 is a flowchart showing a method of operating a UE according to an embodiment.

FIG. 9 is a flowchart showing a method of operating a UE according to another embodiment.

FIGS. 10A to 10B illustrate exemplary formats of an LR link quality report according to an embodiment.

FIG. 11 illustrates procedures of a UE and a base station according to an embodiment.

FIG. 12 is a block diagram showing apparatuses according to an embodiment of the disclosure.

FIG. 13 is a block diagram showing a terminal according to an embodiment of the disclosure.

FIG. 14 is a block diagram of a processor in accordance with an embodiment.

FIG. 15 is a detailed block diagram of a transceiver of a first apparatus shown in FIG. 12 or a transceiving unit of an apparatus shown in FIG. 13.

### DETAILED DESCRIPTION

The technical terms used in this document are for merely describing specific embodiments and should not be considered limiting the embodiments of disclosure. Unless defined otherwise, the technical terms used in this document should be interpreted as commonly understood by those skilled in the art but not too broadly or too narrowly. If any technical terms used here do not precisely convey the intended meaning of the disclosure, they should be replaced with or interpreted as technical terms that accurately understood by those skilled in the art. The general terms used in this document should be interpreted according to their dictionary definitions, without overly narrow interpretations.

The singular form used in the disclosure includes the plural unless the context dictates otherwise. The term ‘include’ or ‘have’ may represent the presence of features, numbers, steps, operations, components, parts or the combination thereof described in the disclosure. The term ‘include’ or ‘have’ may not exclude the presence or addition of another feature, another number, another step, another operation, another component, another part or the combination thereof.

The terms ‘first’ and ‘second’ are used to describe various components without limiting them to these specific terms. The terms ‘first’ and ‘second’ are only used to distinguish one component from another component. For example, a first component may be named as a second component without departing from the scope of the disclosure.

When an element or layer is referred to as being “connected to” or “coupled to” another element or layer, it may be directly connected or coupled to the other element or layer, there might be intervening elements or layers. In contrast, when an element or layer is referred to as being “directly connected to” or “directly coupled to” another element or layer, there are no intervening elements or layers.

Hereinafter, the exemplary embodiments of the disclosure will be described in detail with reference to the accompanying drawings. In describing the disclosure, for ease of understanding, the same reference numerals will be used throughout the drawings for the same components, and repetitive description on these components will be omitted. Detailed description on well-known arts that may obscure the essence of the disclosure will be omitted. The accompanying drawings are provided to merely facilitate understanding of the embodiment of disclosure and should not be seen as limiting. It should be recognized that the essence of this disclosure extends the illustrations, encompassing, replacements or equivalents in variations of what is shown in the drawings.

In this disclosure, “A or B” may mean “only A”, “only B”, or “both A and B”. In other words, “A or B” in the disclosure may be interpreted as “A and/or B”. For example, “A, B or C” may mean “only A”, “only B”, “only C”, or “any combination of A, B and C”.

In this disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In this disclosure, “at least one of A and B” may mean “only A”, “only B” or “both A and B”. In addition, “at least one of A or B” or “at least one of A and/or B” may be interpreted as the same as “at least one of A and B”.

In addition, “at least one of A, B and C” may mean “only A”, “only B”, “only C”, or “any combination of A, B and C”. Further, “at least one of A, B or C” or “at least one of A, B and/or C” may mean “at least one of A, B and C”.

Also, parentheses used in this disclosure may mean “for example”. For example, “control information (PDCCH)” may mean that “PDCCH” is an example of “control information”. However, “control information” in this disclosure is not limited to “PDCCH”. As another example, “control information (i.e., PDCCH)”, may also mean that “PDCCH” is an example of “control information”.

Each of the technical features described in one drawing in this disclosure may be implemented independently or simultaneously.

In the accompanying drawings, user equipment (UE) is illustrated as an example and may be referred to as a terminal, mobile equipment (ME), and the like. UE may be a portable device such as a laptop computer, a mobile phone, a personal digital assistance (PDA), a smart phone, a multimedia device, or the like. UE may be a non-portable device such as a personal computer (PC) or a vehicle-mounted device.

Hereinafter, the UE may be as an example of a device capable of wireless communication. The UE may be referred to as a wireless communication device, a wireless device, or a wireless apparatus. The operation performed by the UE may be applicable to any device capable of wireless communication. A device capable of wireless communication may also be referred to as a radio communication device, a wireless device, or a wireless apparatus.

A base station generally refers to a fixed station that communicates with a wireless device. The base station may include an evolved-NodeB (eNodeB), an evolved-NodeB (eNB), a BTS (Base Transceiver System), an access point (Access Point), gNB (Next generation NodeB), RRH (remote radio head), TP (transmission point), RP (reception point), and the repeater (relay).

While embodiments of the disclosure are described based on an long term evolution (LTE) system, an LTE-advanced (LTE-A) system, and an new radio (NR) system, such embodiments may be applicable to any communication system that fits the described criteria.

### <Wireless Communication System>

With the success of long-term evolution (LTE)/LTE-A (LTE-Advanced) for the 4th generation mobile communication, the next generation mobile communication (e.g., 5th generation: also known as 5G mobile communication) has been commercialized and the follow-up studies are also ongoing.

The 5th generation mobile communications, as defined by the International Telecommunication Union (ITU), provide a data transmission rate of up to 20 Gbps and a minimum actual transmission rate of at least 100 Mbps anywhere. The official name of the 5th generation mobile telecommunications is ‘IMT-2020’.

ITU proposes three usage scenarios: enhanced Mobile Broadband (eMBB), massive Machine Type Communication (mMTC) and Ultra Reliable and Low Latency Communications (URLLC).

URLLC is a usage scenario requiring high reliability and low latency. For example, services such as automatic driving, factory automation, augmented reality require high reliability and low latency (e.g., a delay time of less than 1 ms). The delay time of current 4G (e.g., LTE) is statistically about 21 to 43 ms (best 10%) and about 33 to 75 ms (median), which insufficient to support services requiring a delay time of about 1 ms or less. Meanwhile, eMBB is a usage scenario that requires mobile ultra-wideband.

That is, the 5G mobile communication system offers a higher capacity compared to current 4G LTE. The 5G mobile communication system may be designed to increase the density of mobile broadband users and support device to device (D2D), high stability, and machine type communication (MTC). 5G research and development focus on achieving lower latency times and lower battery consumption compared to 4G mobile communication systems, enhancing the implementation of the Internet of things (IoTs). A new radio access technology, known as new RAT or NR, may be introduced for such 5G mobile communication.

An NR frequency band is defined to include two frequency ranges FR1 and FR2. Table 1 below shows an example of the two frequency ranges FR1 and FR2. However, the numerical values associated with each frequency range may be subject to change, and the embodiments are not limited thereto. For convenience of description, FR1 in the NR system may refer to a Sub-6 GHz range, and FR2 may refer to an above-6 GHz range, which may be called millimeter waves (mmWs).

TABLE 1

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

The numerical values of the frequency ranges may be subject to change in the NR system. For example, FR1 may range from about 410 MHz to 7125 MHz as listed in [Table 1]. That is, FR1 may include a frequency band of 6 GHz (or 5850, 5900, and 5925 MHz) or higher. For example, the frequency band of 6 GHz (or 5850, 5900, and 5925 MHz) or higher may include an unlicensed band. The unlicensed band may be used for various purposes, for example, vehicle communication (e.g., autonomous driving).

The 3GPP communication standards define downlink (DL) physical channels and DL physical signals. DL physical channels are related to resource elements (REs) that convey information from a higher layer while DL physical signals, used in the physical layer, correspond to REs that do not carry information from a higher layer. For example, DL physical channels include physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH). DL physical signals include reference signals (RSs) and synchronization signals (SSs). A reference signal (RS) is also known as a pilot signal and has a predefined special waveform known to both a gNode B (gNB) and a UE. For example, DL RSs include cell specific RS, UE-specific RS (UE-RS), positioning RS (PRS), and channel state information RS (CSI-RS). The 3GPP LTE/LTE-A standards also define uplink (UL) physical channels and UL physical signals. UL channels correspond to REs with information from a higher layer. UL physical signals are used in the physical layer and correspond to REs which do not carry information from a higher layer. For example, UL physical channels include physical uplink shared channel (PUSCH), physical uplink control channel (PUCCH), and physical random access channel (PRACH). UL physical signals include a demodulation reference signal (DMRS) for a UL control/data signal, and a sounding reference signal (SRS) used for UL channel measurement.

In this disclosure, PDCCH/PCFICH/PHICH/PDSCH refers to a set of time-frequency resources or a set of REs carrying downlink control information (DCI)/a control format indicator (CFI)/a DL acknowledgement/negative acknowledgement (ACK/NACK)/DL data. Further, PUCCH/PUSCH/PRACH refers to a set of time-frequency resources or a set of REs carrying UL control information (UCI)/UL data/a random access signal.

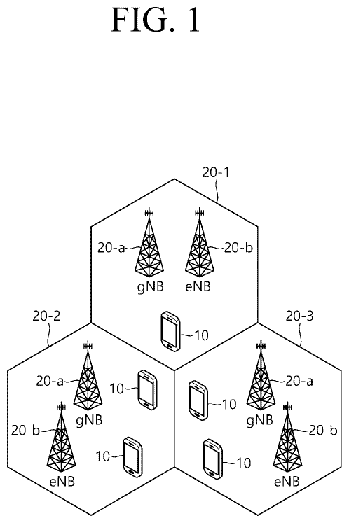

FIG. 1 is a diagram illustrating a wireless communication system.

Referring to FIG. 1, the wireless communication system may include at least one base station (BS). For example, the BSs may include a gNodeB (or gNB) 20a and an eNodeB (or eNB) 20b. The gNB 20a supports 5G mobile communication. The eNB 20b supports 4G mobile communication, that is, long term evolution (LTE).

Each BS 20a and 20b provides a communication service for a specific geographic area (commonly referred to as a cell) (20-1, 20-2, 20-3). The cell may also be divided into a plurality of areas (referred to as sectors).

A user equipment (UE) typically belongs to one cell, and the cell to which the UE belongs is called a serving cell. A base station providing a communication service to a serving cell is referred to as a serving base station (serving BS). Since the wireless communication system is a cellular system, there are other cells adjacent to the serving cell. The other cell adjacent to the serving cell is referred to as a neighbor cell. A base station that provides a communication service to a neighboring cell is referred to as a neighbor BS. The serving cell and the neighboring cell are relatively determined based on the UE.

Hereinafter, downlink means communication from the base station 20 to the UE 10, and uplink means communication from the UE 10 to the base station 20. In the downlink, a transmitter may be a part of the base station 20, and a receiver may be a part of the UE 10. In the uplink, the transmitter may be a part of the UE 10, and the receiver may be a part of the base station 20.

In a wireless communication system, there are primarily two schemes: frequency division duplex (FDD) scheme and time division duplex (TDD) scheme. In the FDD scheme, uplink transmission and downlink transmission occur on different frequency bands. Conversely, the TDD scheme allows both uplink transmission and downlink transmission to use the same frequency band, but at different times. A key characteristic of the TDD scheme is the substantial reciprocity of the channel response, meaning that the downlink channel response and the uplink channel response are almost identical within a given frequency domain. This reciprocity in TDD-based radio communication systems enables the estimation of the downlink channel response from the uplink channel response. In the TDD scheme, since uplink transmission and downlink transmission are time-divided in the entire frequency band, it is not possible to simultaneously perform downlink transmission by the base station and uplink transmission by the UE. In a TDD system where uplink transmission and downlink transmission are divided into subframe units, uplink transmission and downlink transmission are performed in different subframes.

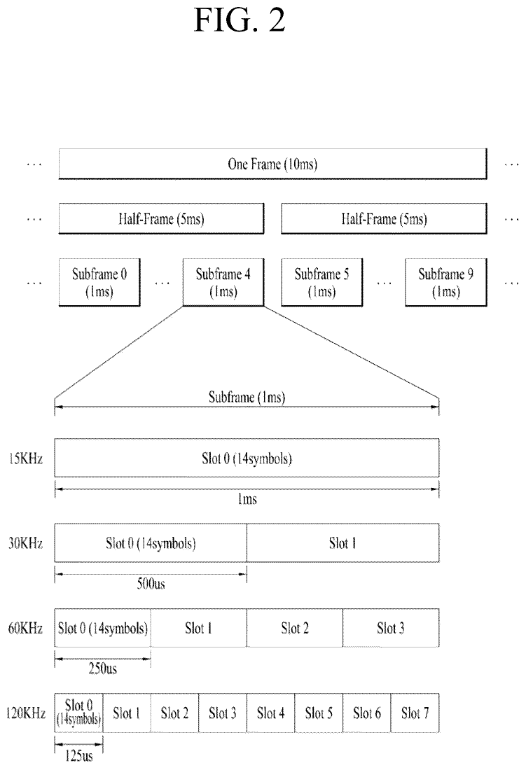

FIG. 2 is a diagram illustrating a structure of a radio frame used in new radio (NR).

In NR, UL and DL transmissions are configured in frames. Each radio frame has a length of 10 ms and is divided into two 5-ms half frames (HFs). Each half frame is divided into five 1-ms subframes. A subframe is divided into one or more slots, and the number of slots in a subframe depends on the subcarrier spacing (SCS). Each slot includes 12 or 14 OFDM(A) symbols according to a Cyclic Prefix (CP). With a normal CP, a slot includes 14 OFDM symbols. With an extended CP, a slot includes 12 OFDM symbols. A symbol may include an OFDM symbol (CP-OFDM symbol) and an SC-FDMA symbol (or DFT-s-OFDM symbol).

### <Support of Various Numerologies>

As wireless communication technology advances, the NR system may offer various numerologies to terminals. For example, when a subcarrier spacing (SCS) is set at 15 kHz, it supports a broad range of the typical cellular bands. When a subcarrier spacing (SCS) is set at 30 kHz/60 kHz, it supports a dense-urban, lower latency, wider carrier bandwidth. When the SCS is 60 kHz or higher, it supports a bandwidth greater than 24.25 GHz in order to overcome phase noise.

These numerologies may be defined by the cyclic prefix (CP) length and the SCS. A single cell in the NR system is capable of providing multiple numerologies to terminals. Table 2 below shows the relationship between the subcarrier spacing, corresponding CP length, and the index of a numerology (represented by μ).

TABLE 2

| μ | Δf = 2^{μ} · 15 [kHz] | CP |
|---|---|---|
| 0 | 15 | normal |
| 1 | 30 | normal |
| 2 | 60 | normal, |
| | | extended |
| 3 | 120 | normal |
| 4 | 240 | normal |
| 5 | 480 | normal |
| 6 | 960 | normal |

Table 3 below shows the number of OFDM symbols per slot (N^{slot}_{symb}), the number of slots per frame (N^{frame,μ}ₛₗₒₜ), and the number of slots per subframe (N^{subframe,μ}ₛₗₒₜ) according to each numerology expressed by μ in the case of a normal CP.

TABLE 3

| μ | Δf = 2^{μ} · 15 [kHz] | N^{slot}_{symb} | N^{frame, μ}ₛₗₒₜ | N^{subframe, μ}ₛₗₒₜ |
|---|---|---|---|---|
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

Table 4 below shows the number of OFDM symbols per slot (N^{slot}_{symb}), the number of slots per frame (N^{frame,μ}ₛₗₒₜ), and the number of slots per subframe (N^{subframe,μ}ₛₗₒₜ) of a numerology represented by μ in the case of an extended CP.

TABLE 4

| μ | SCS (15*2^{u}) | N^{slot}_{symb} | N^{frame, μ}ₛₗₒₜ | N^{subframe, μ}ₛₗₒₜ |
|---|---|---|---|---|
| 2 | 60 kHz | 12 | 40 | 4 |
| | (u = 2) | | | |

In the NR system, OFDM(A) numerologies (e.g., SCS, CP length, and so on) may be configured differently across multiple cells that are integrated with a single terminal. Accordingly, the duration of time resource may vary among these integrated cells. Here, the duration may be referred to as a section. The time resource may include a subframe, a slot or a transmission time interval (TTI). Further, the time resource may be collectively referred to as a time unit (TU) for simplicity and include the same number of symbols.

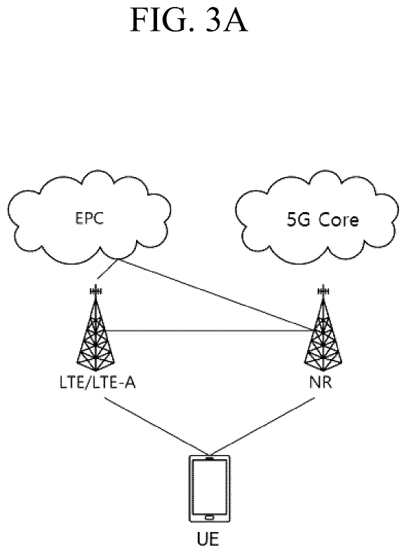

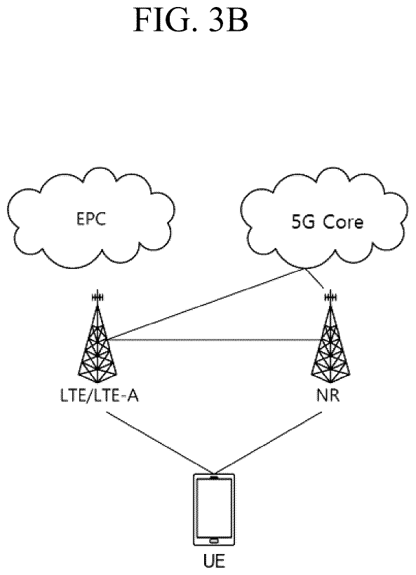

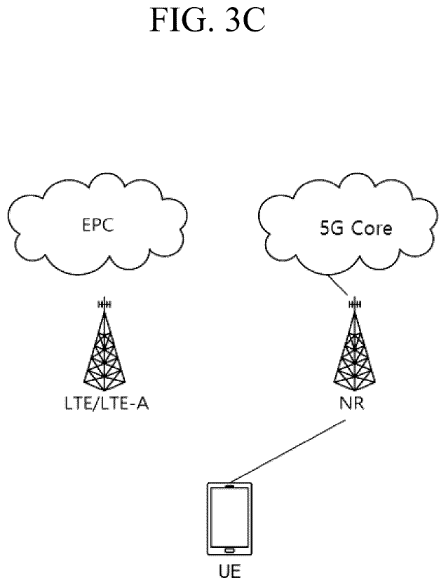

FIGS. 3A to 3C illustrate exemplary architectures for a wireless communication service.

Referring to FIG. 3A, a UE is connected in dual connectivity (DC) with an LTE/LTE-A cell and a NR cell.

The NR cell is connected with a core network for the legacy fourth-generation mobile communication, that is, Evolved Packet core (EPC).

Referring to FIG. 3B, the LTE/LTE-A cell is connected with a core network for 5th generation mobile communication, that is, a 5G core network.

A service provided by the architecture shown in FIGS. 3A and 3B is referred to as a non-standalone (NSA) service.

Referring to FIG. 3C, a UE is connected only with an NR cell. A service provided by this architecture is referred to as a standalone (SA) service.

In the new radio access technology (NR), the use of a downlink subframe for reception from a base station and an uplink subframe for transmission to the base station may be employed. This method may be applicable to both paired spectrums and unpaired spectrums. Paired spectrums involve two subcarriers designated for downlink and uplink operations. For example, one subcarrier within a pair of spectrums may include a pair of a downlink band and an uplink band.

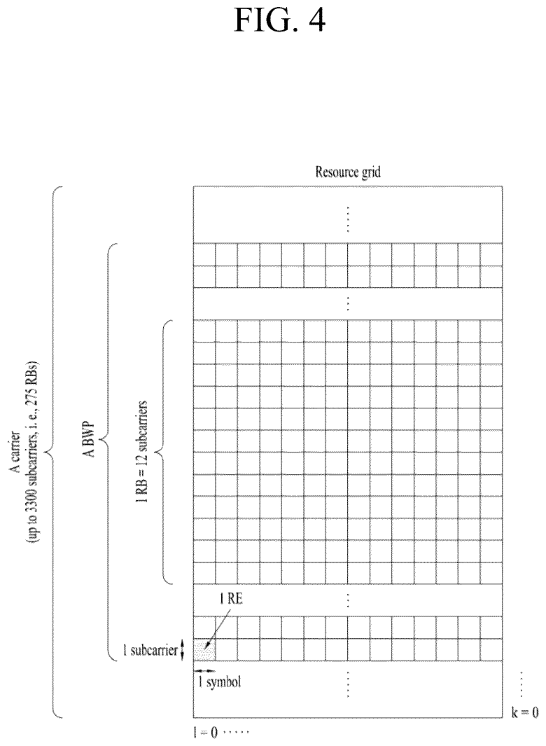

FIG. 4 illustrates a slot structure of an NR frame.

A slot in the NR system includes a plurality of symbols in the time domain. For example, in the case of the normal CP, one slot includes seven symbols. On the other hand, in the case of the extended CP, one slot includes six symbols. A carrier includes a plurality of subcarriers in the frequency domain. A resource block (RB) is defined as a set of consecutive subcarriers (e.g., 12 consecutive subcarriers) in the frequency domain. A bandwidth part (BWP) is defined as a sequence of consecutive physical resource blocks (PRBs) in the frequency domain and may be associated with a specific numerology (e.g., SCS, CP length, etc.). A terminal may be configured with up to N (e.g., five) BWPs in each of downlink and uplink. Downlink or uplink transmission is performed through an activated BWP. Among the BWPs configured for the terminal, only one BWP may be activated at a given time. In the resource grid, each element is referred to as a resource element (RE), and one complex symbol may be mapped thereto.

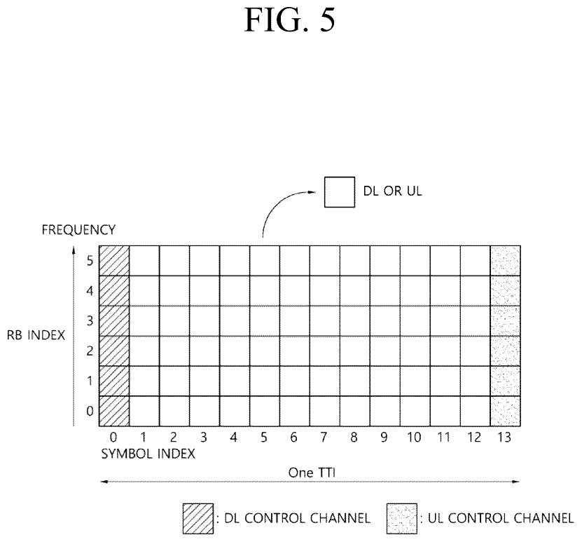

FIG. 5 shows an example of a subframe type in NR.

In NR (or new RAT), a Transmission Time Interval (TTI), as shown in FIG. 5, may be referred to as a subframe or slot. The subframe (or slot) may be utilized in a TDD system to minimize data transmission delay. As shown in FIG. 5, a subframe (or slot) includes 14 symbols. The symbol at the head of the subframe (or slot) may be allocated for a DL control channel, and the symbol at the end of the subframe (or slot) may be assigned for a UL control channel. The remaining symbols may be used for either DL data transmission or UL data transmission. This subframe (or slot) structure allows sequential downlink and uplink transmissions in one single subframe (or slot). Accordingly, downlink data may be received in a subframe (or slot) and uplink ACK/NACK may be transmitted in the same subframe (or slot).

Such a subframe (or slot) structure may be referred to as a self-contained subframe (or slot).

The first N symbols in a slot may be used to transmit a DL control channel and referred to as a DL control region, hereinafter. The last M symbols in the slot may be used to transmit a UL control channel and referred to as a UL control region. N and M are integers greater than 0. A resource region between the DL control region and the UL control region may be used for either DL data transmission or UL data transmission and referred to as a data region. For example, a physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region.

Using this subframe (or slot) structure reduces the time required for retransmitting data that has failed in reception, thereby minimizing overall data transmission latency. In such a self-contained subframe (or slot) structure, a time gap may be required for transitioning between a transmission mode and a reception mode or from the reception mode to the transmission mode. To accommodate this, a few OFDM symbols when switch from DL to UL in the subframe structure may be configured to a guard period (GP).

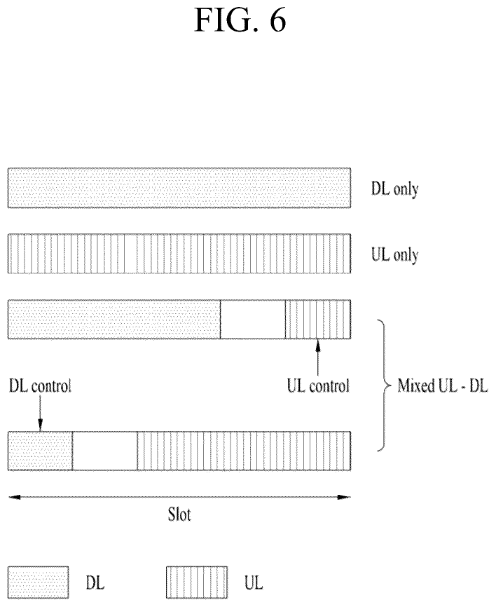

FIG. 6 illustrates a structure of a self-contained slot.

In the NR system, the frames are structured as a self-contained structure, where one single slot includes a DL control channel, either a DL or UL data channel, and UL control channel. For example, the first N symbols in a slot may be used for transmitting a DL control channel and referred to as a DL control region. The last M symbols in the slot may be used for transmitting an UL control channel and referred to as a UL control region. N and M are integers greater than 0. A resource region between the DL control region and the UL control region may be used for either DL data transmission or UL data transmission and referred to as a data region.

For example, the following configurations may be considered. The durations are listed in temporal order.
1. DL only configuration
2. UL only configuration
3. Mixed UL-DL configuration

$$\begin{matrix}- DL region + Guard Period ( GP ) + UL control region \\ - DL control region + GP + UL region\end{matrix}$$

DL region: (i) DL data region, (ii) DL control region+DL data region
UL region: (i) UL data region, (ii) UL data region+UL control region

A physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region. Through the PDCCH, Downlink Control Information (DCI), for example, DL data scheduling information or UL data scheduling data may be transmitted. Through the PUCCH, Uplink Control Information (UCI), for example, ACK/NACK (Positive Acknowledgement/Negative Acknowledgement) information with respect to DL data, Channel State Information (CSI) information, or Scheduling Request (SR) may be transmitted. A guard period (GP) provides a time gap during a process where a gNB and a UE transition from the transmission mode to the reception mode or a process where the gNB and UE transition from the reception mode to the transmission mode. Some of symbols within a subframe that transition from DL to UL mode may be configured as the GP.

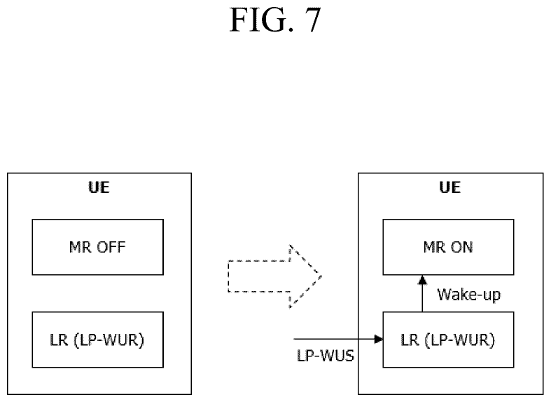

FIG. 7 is a diagram illustrating an exemplary operation of a UE with a low power-wake up receiver (LR).

In the case of discontinuous reception (DRX) applied in NR, a long sleep duration should be used to minimize power consumption of a UE. While long DRX operation effectively reduces power consumption, it makes it difficult to meet the latency requirements of the UE that requires low latency. To support the UE that requires both low latency and low power consumption, the UE must be able to receive a wake-up signal from the base station while consuming the minimum power, even in a short cycle or always ON state. To this end, an ultra-low power receiver, which can be mountable separately from the existing transceiver, has been introduced. 3GPP is currently studying methods of defining the architecture and operation of this receiver. Here, the receiver being defined refers to a receiver that enables the UE to receive only the wake-up signal and related essential signals. It is defined as a separate receiver from the existing transceiver used for transmitting and receiving data. When the UE enters a deep sleep mode or a low power wake up receiver (WUR) mode, the transceiver (i.e. Main Radio, MR Tx/Rx module) used to transceive NR signals/channels is turned off (or stops monitoring PDCCH). Meanwhile, only the LP wake-up receiver (LR) remains active, allowing the wake-up signal and related essential signals to be received through the LR, thereby drastically reducing the UE's power consumption. In this case, a UE that receives the wake-up signal through that receiver (i.e., LR) may be instructed to switch to a main radio (MR) mode. Upon receiving this instruction, the UE may switch from the LR mode over to the MR mode and resumes communication using the existing transceiver for transmitting and receiving NR data. FIG. 7 schematically shows the operation of the UE configured with the foregoing LR.

A low power receiver operating in the LR mode may support different signal reception qualities compared to a normal receiver operating in the MR mode. This means that a UE utilizing both receivers may not be able to determine the coverage of the low power receiver solely based on the signal strength of an MR receiver. According to the discussion in 3GPP, the PDCCH monitoring by the LR of the UE is enabled or disabled based on RRC signaling of the base station (gNB). However, it has not been decided on what basis the base station will enable/disable the LR of the UE. Furthermore, whether to support UE assistance information for this functionality remains under discussion. As mentioned above, because the UE's LR is assumed to be designed with a separate receiver module (Rx. Module) from that of the MR receiver, it may be necessary to measure the downlink signal quality through the LR to assess the LR coverage and to determine whether to apply the LR based on the measured downlink signal quality. However, the current standard specification does not define a solution for this. In addition, the current standard specification does not define a method for reporting the signal quality of the LR. Accordingly, a configuration is required for the base station to determine whether to apply the LR to the UE, along with a specific operation of the UE based on that configuration. In addition, a method is needed for the base station to determine the UE's LR coverage, and the base station must enable/disable the UE's LR based on this method.

The disclosure, conceived to address the foregoing problems, proposes a method for a UE to receive event configuration information related to signal strength/quality for a downlink channel, measured through a low power wakeup receiver (LR), from a base station, to perform measurement through the LR based on the received LR-related event configuration information, and to perform a PDCCH monitoring operation based on the measurement.

Furthermore, the disclosure proposes a method for a UE to receive event configuration information related to signal strength/quality for a downlink channel measured by a low power wakeup receiver (LR) from a base station, to perform measurement through the LR based on the received LR-related event configuration information, and to perform measurement reporting accordingly.

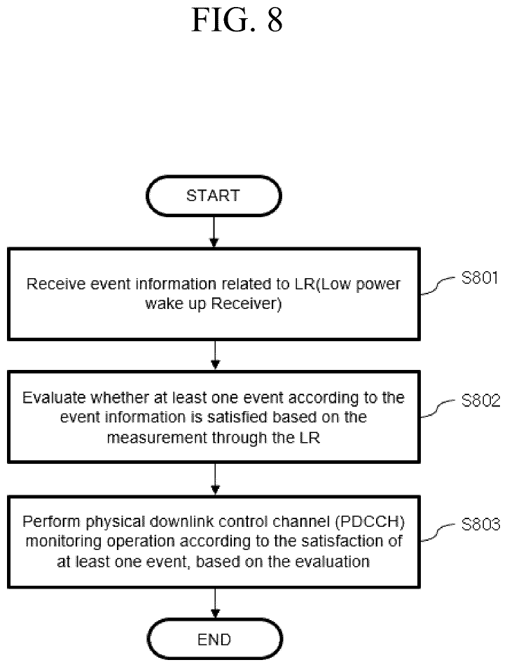

FIG. 8 is a flowchart showing a method of operating a UE according to an embodiment.

Referring to FIG. 8, a UE receives event information related to a low power wake up receiver (LR) from a base station (S801). According to an embodiment, the event information may be received through a configuration message for measurement on an LR link (and/or beam) received from the base station. This configuration message may include a resource configuration for a reference signal (e.g., LP-synchronization signal (SS) or LP-channel state information-reference signal (CSI-RS)) to perform measurement on the LR signal quality.

In this specification, the following two events may be defined as LR-related events, and at least one of them may be configured through event information from the base station.
1. Event LR_A1 (serving on LR becomes better than absolute threshold)
2. Event LR_A2 (serving for LR becomes worse than absolute threshold)

The UE evaluates whether at least one event specified in the received event information is satisfied based on the measurement conducted using the LR (S802) and performs a physical downlink control channel (PDCCH) monitoring operation if the event is satisfied based on the evaluation (S803). In other words, the UE determines whether to initiate or discontinue Low Power-Wake Up Signal (LP-WUS) monitoring through the LR based on the received LR-related event information. The PDCCH monitoring operation while performing the LP-WUS monitoring means that the PDCCH monitoring is activated or resumed when the LP-WUS is received via the LP-WUS monitoring. The PDCCH monitoring operation when the LP-WUS monitoring is stopped means that legacy PDCCH monitoring is performed without the LP-WUS monitoring.

The measurement using the LR may be one or both of a Reference Signal Received Power (RSRP) measurement and a Reference Signal Received Quality (RSRQ) measurement.

When either the RSRP measurement and the RSRQ measurement is greater than or equal to a threshold, Low Power-Wake Up Signal (LP-WUS) monitoring may be performed through the LR. Conversely, when either the RSRP measurement and the RSRQ measurement is less than or equal to the threshold, Low Power-Wake Up Signal (LP-WUS) monitoring may be stopped through the LR.

Meanwhile, the UE may evaluate whether at least one event specified in the received event information is satisfied based on the measurement conducted using the LR and transmit report information if at least one event is satisfied, to the base station based on the evaluation. Here, the report information transmitted by the UE to the base station may include at least one of i) information indicating whether the LR is in or out of coverage, ii) measurement result information using the LR, and iii) indication information indicating a result report of the measurement using the LR. In addition, the report information transmitted by the UE to the base station may be transmitted to the base station through a main radio transceiver (MR).

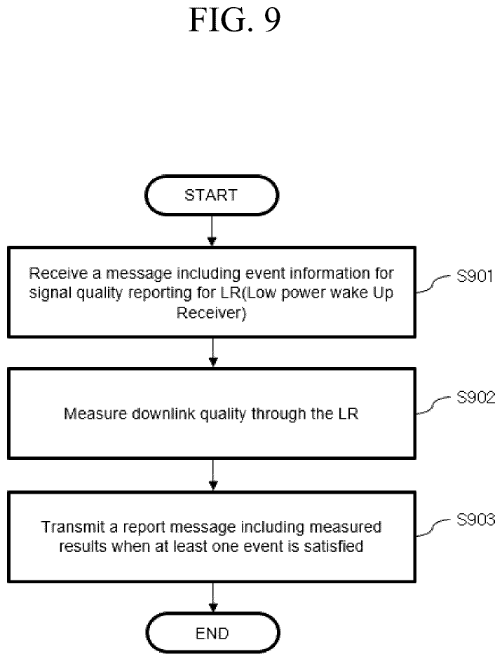

FIG. 9 is a flowchart showing a method of operating a UE according to another embodiment.

Furthermore, the disclosure proposes a method for a UE with a low-power receiver module (Rx. Module) to report downlink quality measured using an LR to a base station. Specifically, the disclosure proposes a method of configuring a UE to measure and report signal quality for an LR, and introduces an LR quality measurement and reporting operation of the UE using the same. More specifically, the base station sends a UE a message for configuring resources for a reference signal (e.g., LP-SS or LP-CSI-RS) to measure LR signal quality and defining a reporting method associated therewith. The report may be configured as a periodic/aperiodic/event-based report and transmitted through the uplink resources of the MR. The report message may include an indicator specifying that the report is about the downlink signal quality/strength for the LR.

If the base station is configured to perform event-based reporting for LR downlink signals to the UE, one or more events, including related thresholds, may be configured for the UE, and the UE evaluates whether the reporting event is satisfied through the downlink quality measurement using the LR. If at least one of the configured events is satisfied, the UE reports on the link quality measurement result using the LR to the base station. The result may be transmitted using layer 3 (L3) signaling via RRC or through PHY/MAC as L1/L2 signaling.

Referring to FIG. 9, the UE receives a message including event information for reporting on the signal quality (or strength) for the low power wake up receiver (LR) from the base station (S901). Here, the event information may include at least one event configured for the UE. Then, the UE measures the downlink quality (or strength) through the LR (S902). When at least one event configured for the UE is satisfied, the UE transmits the report message including the measured result to the base station (S903).

Meanwhile, when the UE reports LR measurement results to the base station, the report may include an indicator specifying the measurement result of the signal quality/strength for the LR. This applies to all the periodic/aperiodic/semi-persistent/event-based reports.

In addition, the disclosure proposes to define LR-related reporting events that the base station may configure for the UE to perform the foregoing operations. The UE that performs LR measurement through L3 filtering may report the corresponding measurement result through L3 message. In this case, the base station may define a new measObjectLR instead of the previously defined measObjectNR for the UE or may add a measurement object related to the LR in addition to measObjectNR. This may include resource information related to channel measurements, such as LP-SS to LR, and configuration information for reporting may also be defined as reportConfigLR instead of reportConfigNR, or may extend events for the LR within the existing reportConfigNR. The following is an example where measObjectLR and reportCofigLR are defined as measObjectMR and reportConfigMR in the definition of a new event.

In other words, an event for reporting L3 measurement results based on the LR measurement data may be newly defined as follows.
1. Event LR_A1 (serving on LR becomes better than absolute threshold)

The UE considers the serving cell corresponding to the measObjectLR associated with this event. The Event LR_A1 has entering and leaving conditions, as shown in Table 5.

```
TABLE 5
Inequality LR_A1-1 (Entering condition)
Ms − Hys > Thresh
Inequality LR_A1-2 (Leaving condition)
Ms + Hys < Thresh
The variables in the formula are defined as follows:
  Ms is the measurement result of the serving cell on LR, not taking into
    account any offsets.
  Hys is the hysteresis parameter for this event (i.e. hysteresis as defined
    within reportConfigLR for this event).
  Thresh is the threshold parameter for this event (i.e. a1-Threshold as
    defined within reportConfigLR for this event).
  Ms is expressed in dBm in case of RSRP, or in dB in case of RSRQ and
    RS-SINR.
  Hys is expressed in dB.
  Thresh is expressed in the same unit as Ms.
```

2. Event LR_A2 (serving for LR becomes worse than absolute threshold)

The UE considers the serving cell associated with measObjectLR for this event. The Event LR_A2 has entering and leaving conditions as shown in Table 6.

```
TABLE 6
Inequality LR_A2-1 (Entering condition)
Ms + Hys < Thresh
Inequality LR_A2-2 (Leaving condition)
Ms − Hys > Thresh
The variables in the formula are defined as follows:
  Ms is the measurement result of the serving cell on LR, not taking into
    account any offsets.
  Hys is the hysteresis parameter for this event (i.e. hysteresis as defined
    within reportConfigLR for this event).
  Thresh is the threshold parameter for this event (i.e. a2-Threshold as
    defined within reportConfigLR for this event).
  Ms is expressed in dBm in case of RSRP, or in dB in case of RSRQ and
    RS-SINR.
  Hys is expressed in dB.
  Thresh is expressed in the same unit as Ms.
```

The base station may transmit an RRC message including at least one of the previously defined events to the UE that supports an LR function. The UE that receives the RRC message measures link quality for a downlink signal using the LR through a reference signal defined for measuring the LP-SS or downlink quality for the LR and evaluates whether the measured result satisfies the configured event. If the UE's evaluation result shows that at least one of the events received from the base station is satisfied, the UE transmits a report message including the corresponding result to the base station. Such a report message may be sent through RRC or through L1/L2 signaling, and may include at least one piece of the following information.
Indicator indicating the report on the results measured through the LR
Event information that triggers the report, where the event information may indicate Event LR_A1 or LR_A2, or may mean information about the coverage-in or -out of the LR. In the case of periodic reporting, this information may be omitted.
Result value measured using the LR. Here, the result value may be one or more of Reference Signal Received Power (RSRP), Reference Signal Received Quality (RSRQ), and Reference Signal-Signal to Noise Ratio (RS-SINR), and may include a result specified by the base station. If beam level reporting is performed, a measurement result value for each beam may be reported including the following information: (e.g., index) an index identifying beams satisfying the event, along with their corresponding result values; or an index identifying the highest N beams among those satisfying the event, along with their corresponding result values.

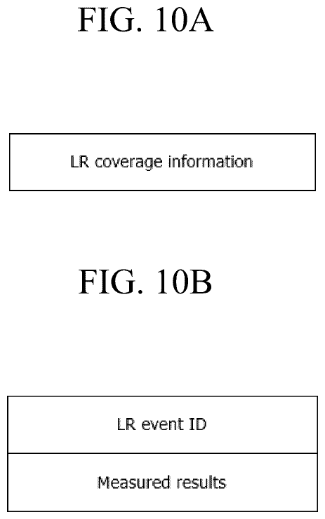

FIGS. 10A to 10B illustrate exemplary formats of an LR link quality report according to an embodiment of this specification.

First, a method of reporting the above-mentioned information to the base station through the RRC message will be described. The UE transmits a message including at least one piece of the s information to the base station according to a reporting method for the LR, configured by the base station. If the reporting method is based on an event, the UE transmits the RRC message including the link quality result measured using the LR to the base station when at least one of the configured events is satisfied. This allows the base station to recognize that the report is for the LR by receiving a message including measId corresponding to measOjbectId and ReportConfigId configured for the LR, or to distinguish the report from the measurement result for the MR by defining an explicit indicator.

Next, a reporting method using a MAC control element (CE) will be described. The MAC CE may be appropriately used as an indicator to notify the occurrence of a specific event. When at least one of the events related to the LR that is configured by the base station is satisfied, the UE transmits a MAC CE including at least one piece of the above-mentioned information to the base station. The MAC CE may indicate that a specific event has occurred based on a measurement result for the LR and may be defined as signaling that conveys event information or whether the UE's LR is in the coverage (FIG. 10A). Alternatively, the MAC CE may be defined to include both the results of the LR measurement together with the event information. If the measured results are reported at the beam level, the measured results may be added according to the number of beams being reported (FIG. 10B).

Next, a method of reporting on the result value using the LR through L1 signaling will be described. For reporting via L1 signaling, the base station may be configured to report on the L3 filtering result through the L1 signaling, or may be configured to report the L1 filtering measurement result through the L1 resource allocation and the related L1 reporting setup through the existing channel state information (CSI) configuration.

First, when the L1 resources are used to report the measurement results obtained through the L3 filtering, the base station may include L1 resource configuration information (e.g., allocation details) for reporting this information in the LR measurement configuration message. The reported information may include at least one of the following: an indicator indicating (e.g., specifying) a report on a result measured through the LR; event information that triggers the report; and a result value measured through the LR. Additionally, it may be configured to report only on 1-bit information as signaling that indicates whether the UE's LR is in the coverage. The corresponding L1 report may also be configured as a periodic/aperiodic/semi-persistent or event-based report. This means that event-configured measurement results based on the L3 filtering results are transmitted through the L1 signaling.

Next, the use of L1 resources to report measurement results based on the L1 filtering will be described. Like the typical CSI configuration, the base station may transmit CSI resources and reporting configurations to the UE so that the UE can measure signal quality or strength of an LR downlink channel and report the results. Here, the CSI resource configuration defines the resources for the reference signals used in the downlink channel measurement for the LR, and the reporting is configured to be performed using the PUCCH/PUSCH resources of the MR. In this case, the reporting of the UE is performed using the MR UL resources but needs to indicate that the measurement results for the LR are reported. In other words, the base station may configure the CSI resource configuration for the LR and the corresponding CSI reporting method together, where the reporting method (periodic/aperiodic/semi-persistent) may be configured according to the resource transmission methods, as in the typical method, with the event-based reporting additionally defined. If the reporting is configured to be performed when the event condition is met, event information for CSI reporting for the LR may be included in the CSI reporting configuration. The corresponding event may be configured by defining a threshold for link-level/beam-level RSRP/RSRQ/SINR measured for the LR This means that the L1 filtering-based measurement results are transmitted through the L1 signaling. The UE configured with the event-based reporting performs a corresponding report to the base station only when the event condition is satisfied. This means that the previously proposed L2 (MAC CE), L3 (RRC) signaling may be used in relation to the CSI resource configuration but may also be reported through the L1 signaling. If the reported is transmitted through the L1 resources, the UE may preferentially transmit a signal requesting/indicating that the reporting is necessary, thereby including a procedure to activate the relevant L1 resources. The UE reports measurement results for the LR based on the event, using the activated L1 PUCCH/PUSCH resources. Information reported through the L1 resources may include at least one of the previously proposed pieces of information, in addition to the information transmitted in the existing CSI reports. That is, one of the following may be reported: i) the highest N measurement result values for information about the triggered event and the CSI resources satisfying that event; ii) the highest N measurement result values among the CSI resources measured when at least one CSI resource satisfying the event; or iii) the result values of all CSI resources satisfying the event. Additionally, the report may include an additional indicator indicating (e.g., specifying) that the report contains the measurement results using the LR. Alternatively, as proposed above, the report may be configured to contain only 1-bit information, as signaling that indicates whether the LR is in coverage.

In addition, reporting LR channel measurement results based on the satisfaction of specific event conditions, or reporting periodic/aperiodic LR channel measurement results that exceed or fall below a specific threshold, may be utilized as implicit notification information for LP-WUS monitoring. This applies to a UE where the PDCCH monitoring by the LP-WUS is enabled, or a UE where PDCCH monitoring by LP-WUS is enabled and activated through L1/L2 signaling. For example, when a UE where thePDCCH monitoring by the LP-WUS is configured to be enabled by the base station, or a UE where the PDCCH monitoring by the LP-WUS is enabled and activated through the L1/L2 signaling, reports the LR channel measurement results according to the satisfaction of the A1 event condition described above. That is, when it reports the LR downlink signal strength or quality results that are greater than or equal to (or exceeding) a specific threshold, this reporting may be defined as a message that implicitly notifies the base station that the UE is performing the monitoring operation for the LP-WUS. Accordingly, the base station that receives the LR reporting satisfying the corresponding condition may anticipate the UE to perform the monitoring operation for the LP-WUS. On the other hand, when the UE where the PDCCH monitoring operation by the LP-WUS is configured to be enabled or the UE where the PDCCH monitoring operation by the LP-WUS is configured to be enabled and activated through the L1/L2 signaling, reports the LR channel measurement result according to the satisfaction of the A2 event condition described above. That is, when it reports the LR downlink signal strength or quality result that is less than or equal to (or falling below) a specific threshold, this reporting may be defined as a message that implicitly notifies the base station that the UE has stopped monitoring for the LP-WUS. Accordingly, the base station that receives the LR report satisfying the condition may determine that the UE is no longer performing the monitoring operation for the LP-WUS. This may be defined as an implicit notification message about whether the UE is performing the monitoring operation for the LP-WUS based on whether the measurement result value exceeds or falls below the specific threshold, applicable not only to the event-based LR downlink channel measurement reporting but also to the configured periodic reporting. Alternatively, the LR downlink channel measurement result reporting may be utilized as an LP-WUS monitoring activation/deactivation message for the UE where the PDCCH monitoring operation by the LP-WUS is configured to be enabled. For example, in the UE where the PDCCH monitoring operation by the LP-WUS is enabled, reporting the LR channel measurement results according to the satisfaction of the A1 event condition, i.e., reporting of the LR downlink signal strength or quality results that are greater than or equal to (or exceeding) the specific threshold services as a message for instructing the activation of the LP-WUS monitoring by the UE. The UE notifies the base station of this LP-WUS monitoring activation through the reporting. On the other hand, for the UE where the PDCCH monitoring operation by the LP-WUS is enabled, reporting the LR channel measurement results according to the satisfaction of the A2 event condition, i.e., reporting the LR downlink signal strength or quality results that are less than or equal to (or falling below) the specific threshold serves as a message instructing the deactivation of the LP-WUS monitoring by the UE. The UE then notifies the base station of this LP-WUS monitoring deactivation through the reporting of the measurement results. However, the LR downlink channel measurement result reporting message of the where the PDCCH monitoring operation by the LP-WUS is configured based on the foregoing event conditions may include only a notification for LP-WUS monitoring activation or deactivation according to simplified event configuration conditions, i.e., according to the threshold value configuration, without the LR downlink signal strength or quality measurement result value that is greater than or equal to (or exceeding) the threshold, or less than or equal to (or falling below) the threshold. In this case, the base station anticipates the monitoring of the LP-WUS in the UE will be activated or deactivated starting from a slot after a certain processing period following receiving the reporting or activation/deactivation notification message of the UE.

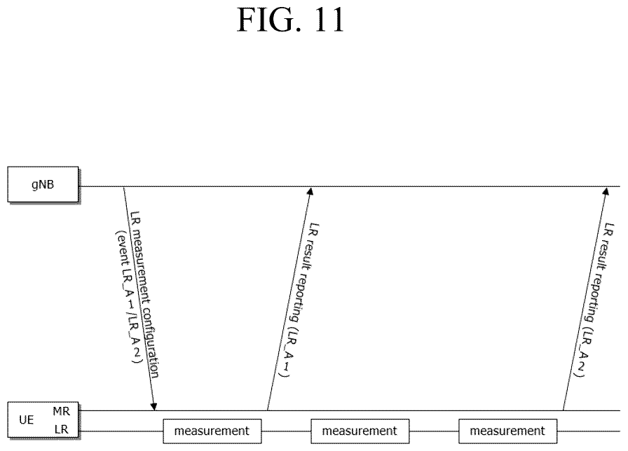

FIG. 11 illustrates procedures of a UE and a base station according to an embodiment.

Below, operations of a UE will be described with reference to FIG. 11.

The UE receives a configuration message related to LR link measurement and result reporting from the base station. The configuration message may include at least one of the following event information.
Event LR_A1 (serving on LR becomes better than absolute threshold)
Event LR_A2 (serving for LR becomes worse than absolute threshold)

The UE evaluates whether a reporting event configured by the base station is satisfied while measuring the LR link quality/strength.

If the event is satisfied, the UE reports the LR link measurement result to the base station. The information reported to the base station may include at least one of the following:
Indicator indicating the report on the results measured through the LR
Event information that triggers the report, where the event information may indicate Event LR_A1 or LR_A2, or may indicate the coverage-in or -out of the LR
Result value measured using the LR

Below, operations of a base station will be described with reference to FIG. 11.

The base station transmits a configuration message related to LR link measurement and result reporting to the UE. The configuration message may include at least one of the following event information.
Event LR_A1 (serving on LR becomes better than absolute threshold)
Event LR_A2 (serving for LR becomes worse than absolute threshold)

The base station receives an LR link measurement result from the UE. The information received from the UE may include at least one of the following:
Indicator indicating the report on the results measured through the LR
Event information that triggers the report, where the event information may indicate Event LR_A1 or LR_A2, or may indicate the coverage-in or -out of the LR
Result value measured using the LR

If the base station is notified that the UE is in the LR coverage (e.g., reported by LR_A1), the base station may enable the LR of the UE and, if it is determined that there is no downlink data, instruct the UE to perform LR activation.

If the base station is notified that the UE is out of the LR coverage (e.g., reported by LR_A2), the base station may disable the LR of the UE, instruct the UE to perform LR deactivation, or determine that the LR of the UE is already deactivated/disabled.

The embodiments described above may be implemented through various means. For example, the embodiments may be implemented in hardware, firmware, software, or a combination thereof. The implementations will be described below with reference to the accompanying drawings.

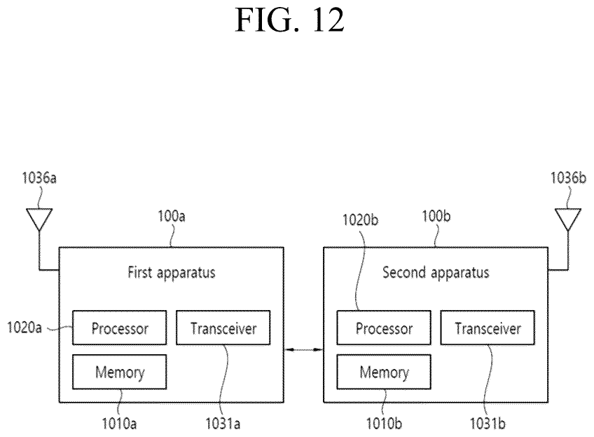

FIG. 12 is a block diagram showing apparatuses according to an embodiment of the disclosure.

Referring to FIG. 12, a wireless communication system may include a first apparatus 100a and a second apparatus 100b.

The first apparatus 100a may include a base station, a network node, a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The second apparatus 100b may include a base station, a network node, a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The first apparatus 100a may include at least one processor such as a processor 1020a, at least one memory such as a memory 1010a, and at least one transceiver such as a transceiver 1031a. The processor 1020a may be tasked with executing the previously mentioned functions, procedures, and/or methods. The processor 1020a may be capable of implementing one or more protocols. For example, the processor 1020a may perform and manage one or more layers of a radio interface protocol. The memory 1010a may be connected to the processor 1020a, and configured to store various types of information and/or instructions. The transceiver 1031a may be connected to the processor 1020a, and controlled to transceive radio signals.

The second apparatus 100b may include at least one processor such as a processor 1020b, at least one memory device such as a memory 1010b, and at least one transceiver such as a transceiver 1031b. The processor 1020b may be tasked with executing the previously mentioned functions, procedures, and/or methods. The processor 1020b may be capable of implementing one or more protocols. For example, the processor 1020b may manage one or more layers of a radio interface protocol. The memory 1010b may be connected to the processor 1020b and configured to store various types of information and/or instructions. The transceiver 1031b may be connected to the processor 1020b and controlled to transceive radio signaling.

The memory 1010a and/or the memory 1010b may be respectively connected inside or outside the processor 1020a and/or the processor 1020b and connected to other processors through various technologies such as wired or wireless connection.

The first apparatus 100a and/or the second apparatus 100b may have one or more antennas. For example, an antenna 1036a and/or an antenna 1036b may be configured to transceive a radio signal.

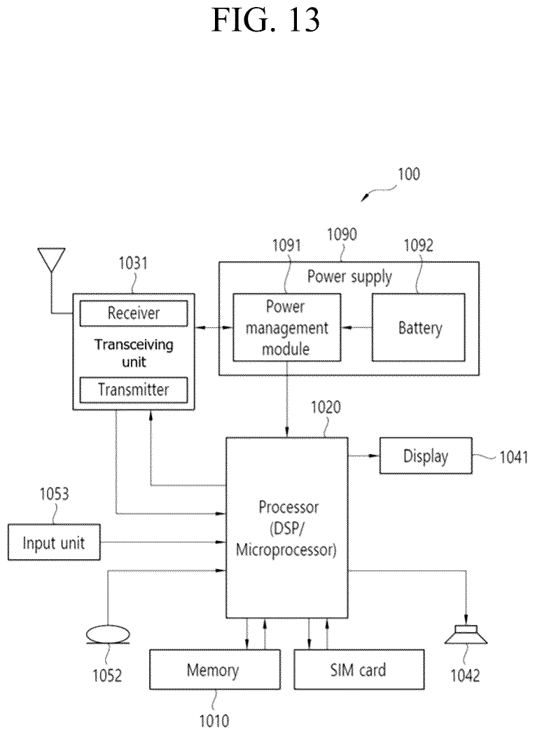

FIG. 13 is a block diagram showing a terminal (e.g., user equipment) according to an embodiment of the disclosure.

In particular, FIG. 13 illustrates the previously described apparatus of FIG. 12 in more detail.

The apparatus includes a memory 1010, a processor 1020, a transceiving unit 1031 (e.g., transceiving circuit), a power management module 1091 (e.g., power management circuit), a battery 1092, a display 1041, an input unit 1053 (e.g., input circuit), a loudspeaker 1042, a microphone 1052, a subscriber identification module (SIM) card, and one or more antennas. Some of the constituent elements is referred to as a unit in the disclosure. However, the embodiments are not limited thereto. For example, such term “unit” is also referred to as a circuit block, a circuit, or a circuit module.

The processor 1020 may be configured to implement the proposed functions, procedures, and/or methods described in the disclosure. The layers of the radio interface protocol may be implemented in the processor 1020. The processor 1020 may include an application-specific integrated circuit (ASIC), other chipsets, logic circuits, and/or data processing devices. The processor 1020 may be an application processor (AP). The processor 1020 may include at least one of a digital signal processor (DSP), a central processing unit (CPU), a graphics processing unit (GPU), and a modulator and demodulator (MODEM). For example, the processor 1020 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel®, KIRIN™ series of processors made by HiSilicon®, or the corresponding next-generation processors.

The power management module 1091 manages a power for the processor 1020 and/or the transceiver 1031. The battery 1092 supplies power to the power management module 1091. The display 1041 outputs the result processed by the processor 1020. The input unit 1053 may be an individual circuit that receives an input from a user or other devices and convey the received input with associated information to the processor 1020. However, the embodiments are not limited thereto. For example, the input unit 1053 may be implemented as at least one of touch keys or buttons to be displayed on the display 1041 when the display 1041 is capable of sensing touches, generating related signals according to the sensed touches, and transferring the signals to the processor 1020. The SIM card is an integrated circuit used to securely store international mobile subscriber identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include read-only memory (ROM), random access memory (RAM), flash memory, a memory card, a storage medium, and/or other storage device. The embodiments described in the disclosure may be implemented as software program or application. In this case, such software program or application may be stored in the memory 1010. In response to a predetermined event, the software program or application stored in the memory 1010 may be fetched and executed by the processor 1020 for performing the function and the method described in this disclosure. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020, receives, and transmits a radio signal under control of the processor 1020. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives audio input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 for a user's recognition or for convenience.

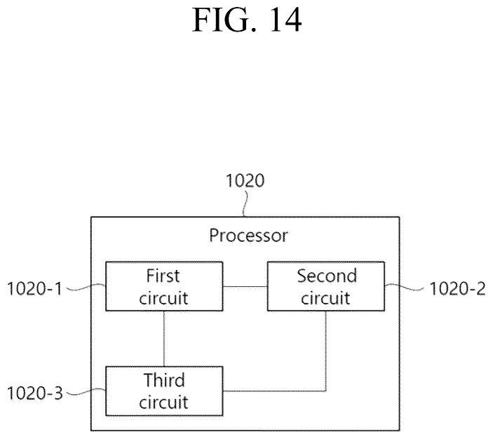

FIG. 14 is a block diagram of a processor in accordance with an embodiment.

Referring to FIG. 14, a processor 1020 may include a plurality of circuits to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an application-specific integrated circuit (ASIC) or an application processor (AP) and may include at least one of a digital signal processor (DSP), a central processing unit (CPU), and a graphics processing unit (GPU).

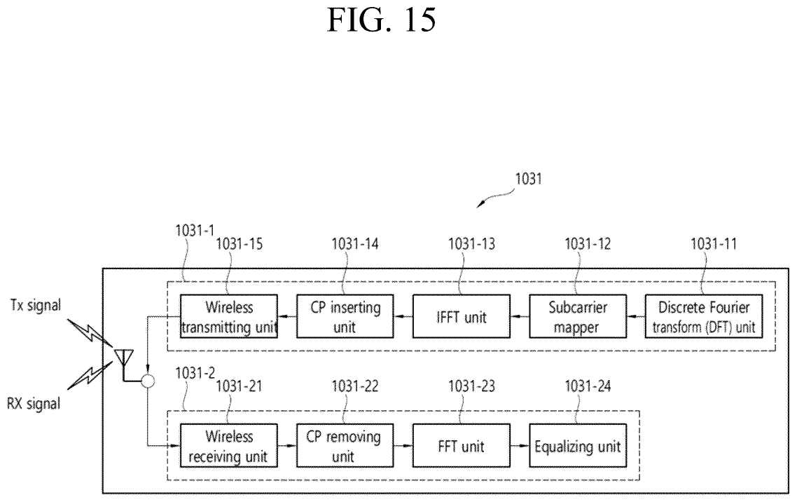

FIG. 15 is a detailed block diagram of a transceiver of a first apparatus shown in FIG. 12 or a transceiving unit of an apparatus shown in FIG. 13.

Referring to FIG. 15, the transceiving unit 1031 (e.g., transceiving circuit) includes a transmitter 1031-1 and a receiver 1031-2. The transmitter 1031-1 includes a discrete Fourier transform (DFT) unit 1031-11 (e.g., DFT circuit), a subcarrier mapper 1031-12 (e.g., subcarrier mapping circuit), an IFFT unit 1031-13 (e.g., IFFT circuit), a cyclic prefix (CP) insertion unit 1031-14 (e.g., CP insertion circuit), and a wireless transmitting unit 1031-15 (e.g., wireless transmitting circuit). The transmitter 1031-1 may further include a modulator. Further, the transmitter 1031-1 may for example include a scramble unit (e.g., scrambling circuit), a modulation mapper, a layer mapper, and a layer permutator, which may be disposed before the DFT unit 1031-11. That is, to prevent a peak-to-average power ratio (PAPR) from increasing, the transmitter 1031-1 subjects information to the DFT unit 1031-11 before mapping a signal to a subcarrier. The signal spread (or pre-coded) by the DFT unit 1031-11 is mapped onto a subcarrier by the subcarrier mapper 1031-12 and made into a signal on the time axis through the IFFT unit 1031-13. Some of constituent elements is referred to as a unit in the disclosure. However, the embodiments are not limited thereto. For example, such term “unit” is also referred to as a circuit block, a circuit, or a circuit module.

The DFT unit 1031-11 performs DFT on input symbols to output complex-valued symbols. For example, when Ntx symbols are input (here, Ntx is a natural number), DFT has a size of Ntx. The DFT unit 1031-11 may be referred to as a transform precoder. The subcarrier mapper 1031-12 maps the complex-valued symbols onto respective subcarriers in the frequency domain. The complex-valued symbols may be mapped onto resource elements corresponding to resource blocks allocated for data transmission. The subcarrier mapper 1031-12 may be referred to as a resource element mapper. The IFFT unit 1031-13 performs IFFT on the input symbols to output a baseband signal for data as a signal in the time domain. The CP inserting unit 1031-14 copies latter part of the baseband signal for data and inserts the latter part in front of the baseband signal for data. CP insertion prevents inter-symbol interference (ISI) and inter-carrier interference (ICI), thereby maintaining orthogonality even in a multipath channel.

On the other hand, the receiver 1031-2 includes a wireless receiving unit 1031-21 (e.g., wireless receiving circuit), a CP removing unit 1031-22 (e.g., CP removing circuit), an FFT unit 1031-23 (e.g., FFT circuit), and an equalizing unit 1031-24 (e.g., equalizing circuit). The wireless receiving unit 1031-21, the CP removing unit 1031-22, and the FFT unit 1031-23 of the receiver 1031-2 perform reverse functions of the wireless transmitting unit 1031-15, the CP inserting unit 1031-14, and the IFFT unit 1031-13 of the transmitter 1031-1. The receiver 1031-2 may further include a demodulator.

According to the embodiments of the disclosure, a power saving mode suitable for the conditions of a UE may be activated based on measurement for a low power wake up receiver (LR). This measurement serves as one piece of information to determine whether the UE-which supports monitoring a downlink signal using only the LR, separate from a main radio transceiver (MR) such as an NR transceiver in a wireless communication system—is within a coverage of switching from the MR over to the LR. Furthermore, the UE may report the LR measurement results to the base station, allowing the base station to configure the power saving mode suitable for the UE's conditions.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

What is claimed is:

1. A method of operating a user equipment (UE) in a wireless communication system, the method comprising:
receiving event information related to a low power wake up receiver (LR);
evaluating whether at least one event included in the event information is satisfied based on measurements using the LR; and
performing a physical downlink control channel (PDCCH) monitoring operation in an event that the at least one event is satisfied based on the evaluation.

2. The method of claim 1, wherein the measurement comprises at least one of reference signal received power (RSRP) measurement and reference signal received quality (RSRQ) measurement.

3. The method of claim 2, wherein low power-wake up signal (LP-WUS) monitoring is performed through the LR, in an event that at least one of the RSRP measurement and the RSRQ measurement is greater than or equal to a threshold.

4. The method of claim 2, wherein low power-wake up signal (LP-WUS) monitoring is stopped through the LR, in an event that at least one of the RSRP measurement and the RSRQ measurement is less than or equal to a threshold.

5. The method of claim 1, further comprising transmitting report information according to whether the at least one event is satisfied, based on the evaluation.

6. The method of claim 5, wherein the report information comprises at least one of: i) information indicating whether the LR is in coverage or out of coverage; ii) information about results of measurement using the LR; and iii) indication information indicating a report on the results of the measurement using the LR.

7. The method of claim 5, wherein the report information is transmitted through a main radio transceiver (MR).

8. A user equipment (UE) in a wireless communication system, comprising:
at least one processor; and
at least one memory configured to store instructions and operably electrically connectable to the at least one processor,
wherein operations performed based on the instructions executed by the at least one processor comprise:
receiving event information related to a low power wake up receiver (LR);
evaluating whether at least one event included in the event information is satisfied based on measurement using the LR; and
performing a physical downlink control channel (PDCCH) monitoring operation in an event that the at least one event is satisfied based on the evaluation.

9. The UE of claim 8, wherein the measurement comprises at least one of reference signal received power (RSRP) measurement and reference signal received quality (RSRQ) measurement.

10. The UE of claim 9, wherein low power-wake up signal (LP-WUS) monitoring is performed through the LR, in an event that at least one of the RSRP measurement and the RSRQ measurement is greater than or equal to a threshold.

11. The UE of claim 9, wherein low power-wake up signal (LP-WUS) monitoring is stopped through the LR, in an event that at least one of the RSRP measurement and the RSRQ measurement is less than or equal to a threshold.

12. The UE of claim 8, wherein operations performed based on the instructions executed by the at least one processor further comprise:
transmitting report information in an event that the at least one event is satisfied based on the evaluation.

13. The UE of claim 12, wherein the report information comprises at least one of: i) information indicating whether the LR is in coverage or out of coverage; ii) information about results of measurement using the LR; and iii) indication information indicating a report on the results of the measurement using the LR.

14. The UE of claim 12, wherein the report information is transmitted through a main radio transceiver (MR).
